(19) United States
(12) Patent Application Publication
(10) Pub. No.: US 2010/0263545 A1
(43) Pub. Date: Oct. 21, 2010

(54) GAS CAPSULE POWERED COFFEE BREWER

(76) Inventors: Curt Morgan, Huntington Beach, CA (US); Vincent Chen, Westminster, CA (US)

Correspondence Address: MARC E. HANKIN, ESQ., 11414 THURSTON CIRCLE, LOS ANGELES, CA, 90049, US

(21) Appl. No.: 12/534,773

(22) Filed: Aug. 3, 2009

Related U.S. Application Data
(60) Provisional application No. 61/170,510, filed on Apr. 17, 2009.

(51) Int. Cl. A47J 31/00; A47J 31/44

(52) U.S. Cl. 99/295; 99/300

(57) ABSTRACT

The present invention is a coffee brewer that uses a one time use, prepackaged, disposable gas propellant capsule to force hot water through ground coffee to create brewed coffee or espresso.

### CROSS-REFERENCE TO RELATED APPLICATIONS

Priority is claimed to U.S. Provisional Patent Application Ser. No. 61/170,510, filed on Apr. 17, 2009, and titled “Gas Capsule Powered Coffee Brewer.” This priority application is expressly incorporated by reference herein as though set forth herein in full.

### BACKGROUND OF THE INVENTION

This invention relates to a hot beverage brewer, and more specifically a portable and self-contained coffee brewer powered by a disposable compressed gas capsule.

Coffee and coffee-based beverages are some of the most popular and universal drinks throughout the entire world. Espresso is a coffee beverage that is brewed by forcing hot water, preferably at a temperature between 85 and 95 degrees centigrade, under pressure, through compacted coffee grounds over a short period of time, typically 20 to 30 seconds. This is generally accomplished with a complicated apparatus involving water boiler chamber and heating elements, electric or manual high-pressure water pumps, valves, and filters. As a result, current espresso brewing devices are typically large, expensive, complicated, and require a skilled operator. Because of the large size and expensive cost, espresso brewing is frequently inconvenient or restricted to small number of venues. The present invention described herein combines the necessary elements, mainly, high pressure, hot water, compacted coffee grounds, and filtration, for brewing high quality espresso in a simple, low cost, portable, self-powered, and convenient device. As a result, a small, simple, low cost chamber which holds a gas capsule, coffee, and hot water can be used by anyone, anywhere to brew high quality coffee or espresso beverages.

In the field of compressed gas powered coffee brewers, U.S. Pat. No. 7,377,207, issued to Hug, discloses a coffee brewer that uses a reusable compressed gas cylinder. Although compressed air powers the brewing of coffee in Hug, the compressed air does not apply pressure directly to the hot water. Rather, the compressed air in Hug drives a hydraulic piston, and it is this hydraulic piston that applies pressure to and displaces the hot water through the coffee grounds. Additionally, the Hug coffee brewer has a multi-use and large refillable air tank, separate and external from the brewing chamber. The compressed air in the Hug patent also requires a release valve to control and regulate air release.

United States Published Patent Application Number 2008/0196593, filed by Shrader, discloses a portable compressed air powered coffee brewer. However, the Shrader coffee brewer is not self contained and discloses that the source of the compressed air is external to the invention. In addition the Shrader brewer relies on an output exit valve to briefly hold pressure and then release the brewed beverage.

United States Published Patent Application Number 2007/0175927, filed by Ozanne, discloses a compressed air powered coffee brewer. However, the Ozanne coffee brewer has elastic walls that compress and deform against the pressure, and the source of compressed air is again a standard refillable tank external to the brewing chamber. In all of these patents compressed air or gas is utilized as the motive force but the propellant container is an existing device and not a part of the patent innovation.

In the field of coffee or espresso brewers with capsulated coffee the following references all disclose coffee brewers with coffee grounds contained in capsules: Shrader; Hug; Ozanne; United States Published Patent Application Number 2007/0272084, filed by Mandralis et al.; and U.S. Pat. No. 4,136,202, issued to Farve. However, the coffee capsules in these references do not contain a propellant or motive force which generates the high pressure for brewing beverages nor are they disclosed in combination with a disposable, single use capsule carrying a propellant or motive force.

The above references fail to disclose a portable and self contained coffee brewer with a disposable, one time use gas propellant capsule which provides the means to generate brewing pressure, eliminating the need for electric water pumps, high pressure hand pumps, valves, pressure regulators, or external tanks. Thus, there is a need in the art for a portable and self-contained coffee brewer powered by a disposable gas propellant capsule disclosed in this patent hereafter.

### SUMMARY OF THE INVENTION

Various embodiments of the invention are directed towards overcoming the above deficiencies of the prior art by providing an easy-to-use, portable, and self-contained coffee brewing device powered by a disposable compressed or liquefied gas capsule.

One embodiment of the present invention is a beverage brewing device comprising: a water chamber; a disposable, one time use gas propellant capsule; a mechanism to vent said capsule; a factory packaged, one time use food capsule; and an outlet with a filtration member. The water chamber is comprised of a base and a lid. The lid connects with the base forming an airtight seal which is capable of containing brewing pressure, typically within the range of 6 to 16 standard atmospheres. The disposable, one time use gas propellant capsule is custom prepackaged containing precisely measured amount of gas propellant, in relation to the total internal volume of the brewing device and beverage type, to generate target brewing pressure which propels hot water through the compacted coffee or food ingredients resulting in infused beverage with ideal emulsification characteristics. The food capsule is a one time use, prepackaged, disposable capsule. The food capsule is inserted into the chamber and punctured at one end to create inlets for liquid to enter the food capsule. The propellant capsule is inserted into the housing of the brewer. A liquid, such as hot water at near boiling temperature, is introduced into the water chamber. The lid is connected to the base, and after an air tight seal is created, the venting mechanism opens a valve or ruptures the gas propellant capsule which releases high pressure gas into the air tight water chamber. The gas propellant release mechanism may be actuated after closing of the lid, or the actuation may be part of the lid closing action. The released gas causes a rise in pressure in the water chamber. The rise in pressure in the water chamber causes the liquid to flow into the food capsule and out of the food capsule, breaking the exit seal, through a filtration member, resulting in an infused beverage. The infused beverage exits the chamber at the outlet. The gas propellant capsule may contain compressed air, nitrogen, carbon dioxide, liquefied carbon dioxide, or other gases which do not adversely affect the beverage. The venting mechanism releases the gas in the propellant capsule by piercing, twisting, or other mechanical means which ruptures the propellant package. The venting mechanism may also release the gas in the propellant capsule by opening a valve, which is built into the package of the propellant capsule. The food capsule contains compacted ground coffee or other food ingredients, sealed in a gas and liquid impermeable package. The outlet side of the food capsule may be punctured by a sharp member of the housing of the brewing device or may be punctured by the pressurized liquid to allow the liquid to pass through to the filtration member then the beverage outlet. Optionally, the gas propellant capsule and the food capsule may be integrally packaged at the factory to form a single brewer insert.

Another embodiment of the present invention is a beverage brewing device comprising: a water chamber; a disposable, one time use gas propellant capsule; a mechanism to vent said capsule; a receptacle for the placement of compacted ground coffee or other food ingredients; and an outlet with a filtration member. The water chamber is comprised of a base and a lid. The lid connects with the base forming an airtight seal which is capable of containing brewing pressure, typically within the range of 6 to 16 standard atmospheres. The disposable, one time use gas propellant capsule is custom prepackaged containing precisely measured amount of gas propellant, in relation to the total internal volume of the brewing device and beverage type, to generate target brewing pressure which propels hot water through the compacted coffee or food ingredients resulting in infused beverage with ideal emulsification characteristics. The receptacle is a space appropriately located in the brewing device where compacted coffee grounds or other food ingredients are placed. The propellant capsule is inserted into the housing of the brewer. A liquid, such as hot water at near boiling temperature, is introduced into the water chamber. The lid is connected to the base, and after an air tight seal is created, the venting mechanism opens a valve or ruptures the gas propellant capsule which releases high pressure gas into the air tight water chamber. The released gas causes a rise in pressure in the water chamber. The rise in pressure in the water chamber causes the liquid to flow into the food receptacle and out through a filtration member, resulting in an infused beverage. The infused beverage exits the chamber at the outlet. The gas propellant capsule may contain compressed air, nitrogen, carbon dioxide, liquefied carbon dioxide, or other gases which do not adversely affect the beverage. The venting mechanism releases the gas in the propellant capsule by piercing, twisting, or other mechanical means which ruptures the propellant package. The venting mechanism may also release the gas in the propellant capsule by opening a valve, which is built into the package of the propellant capsule. The gas propellant release mechanism may be actuated after closing of the lid, or the actuation may be part of the lid closing action. The food receptacle may also receive an adaptor which enables the use of a one time use, prepackaged food capsule instead of being manually packed with coffee grounds or other food ingredients.

Another embodiment of the invention is a beverage brewing device comprising: a chamber; a gas propellant capsule; a venting mechanism; and a food capsule. The chamber is comprised of a base, a lid, and an outlet. The outlet preferably has a filtration member. The gas propellant capsule is preferably prepackaged, disposable, and single use. The gas propellant capsule is inserted into said chamber. The food capsule is prepackaged, disposable, and single use. The food capsule is inserted into said chamber. A liquid is introduced into said chamber. The lid is connected to said base, and wherein connecting said lid to said base establishes an airtight seal capable of withstanding high internal pressure. The venting mechanism causes a pressurized gas to be released from said gas propellant capsule. The pressurized gas causes a rise in pressure in said chamber. The rise in pressure in said chamber causes said liquid to flow into said food capsule and out of said food capsule through said filtration member, resulting in an infused beverage; and the infused beverage exits said chamber at said outlet. Preferably the food capsule contains ground coffee. The gas propellant capsule is further comprised of a valve and wherein said valve is opened by said venting mechanism. The gas propellant capsule is ruptured by an element selected from the group consisting of a sharp point, mechanical contact, and a rotational force exerted by said venting mechanism. The venting mechanism is activated by closing said lid and wherein said venting mechanism is activated only after an airtight seal of said chamber is achieved. The food capsule is further comprised of a top seal and a bottom seal, and wherein said top seal and said bottom seal are liquid impermeable; and wherein at least one of said top seal and said bottom seal rupture at increased pressure to allow said liquid to pass through said at least one ruptured seal. Alternatively, at least one of said top seal and said bottom seal rupture at mechanical contact to allow said liquid to pass through said at least one ruptured seal. The filtration member is integrally connected to said food capsule. The gas propellant capsule is in an interior concentric position and is concentrically surrounded by said food capsule.

Another embodiment of the invention is a beverage brewing device comprising: a chamber; a gas propellant capsule; a venting mechanism; and a food receptacle. The chamber is comprised of a base, a lid, and an outlet; wherein said outlet has a filtration member. The lid connects with said base forming an air tight seal. The gas propellant capsule is a prepackaged, disposable, and single use. The gas propellant capsule is inserted into said chamber. The food receptacle is manually filled with a food by a user. The food receptacle is inserted into said chamber in a location that allows a liquid to flow over said food to produce an infusion; wherein said liquid is introduced into said chamber; wherein said lid is connected to said base, and wherein connecting said lid to said base establishes an airtight seal capable of withstanding high internal pressure. The venting mechanism causes a pressurized gas to be released from said gas propellant capsule; wherein said released gas causes a rise in pressure in said chamber; and wherein said rise in pressure in said chamber causes said liquid to flow into said food receptacle, through said food, and out of said food receptacle through said filtration member, resulting in an infused beverage. The infused beverage exits said chamber at said outlet. The food is ground coffee. The gas propellant capsule is further comprised of a valve and wherein said valve is opened by said venting mechanism. The gas propellant capsule is ruptured by an element selected from the group consisting of a sharp point, mechanical contact, and a rotational force exerted by said venting mechanism. The venting mechanism is activated by closing said lid and wherein said venting mechanism is activated only after an airtight seal of said chamber is achieved. The food receptacle receives a food capsule rather than a food and wherein said food capsule is prepackaged, disposable, and single use.

The disposable, one time use gas propellant capsule is a primary constituent of the present invention. With the use of it, the brewing device requires no power source other than that provided by the preloaded gas propellant. Thus, anyone with this brewing device and hot water can make high quality coffee beverages anywhere. A single use propellant capsule is an improvement over a multiple use external tank for the following reasons. 1) It provides a precise, consistent brewing pressure profile, resulting in predictable, reproducible results. 2) Since the entire propellant content is vented each time, no user control of the amount of gas release is required, removing a source of human error, increasing ease of use, and resulting in consistent output quality. 3) Different propellant capsules with gas charge quantity tailored to be optimum for each of a variety of food capsules can be produced to brew different beverages. 4) It removes the requirement for gas fittings, valves, and pressure or flow regulators. Target brewing pressure is achieved when packaging gas into the propellant capsule by following the Ideal Gas Law. For example, if the target brewing pressure is 132 psi and the combined volume of the chamber space, including the internal capacity of the propellant capsule, the water chamber volume, and the food capsule volume, after the release of the gas from the propellant capsule is 100 ml, compressed nitrogen packaged into a 20 ml propellant capsule capacity at 660 psi would result in the correct brewing pressure. When packaging liquefied gas such as carbon dioxide, the density ratio between the gas and liquid state of CO2 should be taken into account. The vapor pressure of CO2 in a partially filled capsule, e.g. at 30% liquid and 70% gas, is determined by one single factor which is the temperature of the gas/liquid mixture. At 70 degree F., CO2 vapor pressure is about 852 psi and its liquid density is about 770 g/L which is roughly 7 times the gas vapor density. Therefore, when packaging liquefied CO2 at 30% fill, for example, the propellant capsule can be about a third the size of that packaged with compressed air or nitrogen at 660 psi.

An object of the present invention is to provide a beverage brewing device that overcomes the limitations of the prior art.

Another object of the present invention is to provide a portable coffee maker capable of consistently producing high quality espresso coffee.

Another object of the present invention is to provide a brewed beverage maker, powered by a dedicated gas propellant capsule, which is portable and easy to use without the need for electricity supply.

Another object of the present invention is to provide a self-contained, compact, portable, and inexpensive beverage maker using convenient, prepackaged food capsules, and is powered by a dedicated, disposable, one time use compressed gas capsule.

Other features and advantages are inherent in the coffee brewer claimed and disclosed will become apparent to those skilled in the art from the following detailed description and its accompanying drawings.

### BRIEF DESCRIPTION OF THE DRAWINGS

FIG. 1 is an interior view of one embodiment of the invention wherein the gas propellant capsule and coffee capsule are combined in a side by side formation and the brewing cycle is initiated via a separate actuator causing gas capsule venting.

FIG. 2 is an interior view of one embodiment of the invention wherein the gas propellant capsule and coffee capsule are combined in a side by side formation and the brewing cycle is initiated by lid closing causing gas capsule venting.

FIG. 3 is an interior view of one embodiment of the invention wherein the gas propellant capsule and coffee capsule are combined in a side by side formation and the brewing cycle is initiated via a separate actuator operating a gas capsule valve.

FIG. 4 is an interior view of one embodiment of the invention wherein the gas propellant capsule and coffee capsule are combined in a side by side formation and the brewing cycle is initiated via a separate actuator applying a rotational force.

FIG. 5 is a perspective view of one embodiment of a side by side formation integrated gas capsule and coffee capsule.

FIG. 6 is an interior view of one embodiment of the invention wherein the gas capsule is separate and coffee is manually packed into the brewer.

FIG. 7 is an interior view of one embodiment of the invention wherein the gas capsule is separate and an adapter allows for the use of various existing coffee capsules.

FIG. 8 is a perspective view of one embodiment of a concentric formation integrated gas capsule and coffee capsule.

FIG. 9 is an interior view of one embodiment of the invention wherein the gas propellant capsule and coffee capsule are combined in a concentric formation and the brewing cycle is initiated by lid closing causing gas capsule venting.

FIG. 10 is an interior view of one embodiment of the invention wherein the gas capsule is separate and coffee is manually packed into the brewer and an intervening element is employed to force water through the coffee grounds.

### DETAILED DESCRIPTION OF THE DRAWINGS

In the following detailed description of the various embodiments of the invention, numerous specific details are set forth in order to provide a thorough understanding of various embodiments of the invention. However, one or more embodiments of the invention may be practiced without these specific details. In other instances, well-known methods, procedures, and/or components have not been described in detail so as not to unnecessarily obscure aspects of embodiments of the invention.

In the following detailed description of the various embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention. Accordingly, the drawings and detailed description are to be regarded as illustrative in nature and not restrictive. In addition, the reference or non-reference to a particular embodiment of the invention shall not be interpreted to limit the scope of the invention.

The invention is a coffee brewing device powered by a unique, disposable, gas propellant capsule. In order to make high quality espresso, finely ground coffee must be compacted and then held in place while hot water is forced through the grounds at a high pressure. The water flow process preferably occurs over a period of about twenty to thirty seconds. The invention accomplishes this by providing a gas propellant capsule combined with a coffee capsule, preloaded with ground coffee, and a hot water chamber. In use, the multiple capsules combination is preferably installed into a brewing device that locates and holds the capsules in a fixed and sealed position. Hot water is then added to the brewing device chamber and the device is closed. Once closed, the gas propellant capsule is ruptured or opened, which releases the gas propellant. The resultant rise in pressure forces the hot water into the coffee capsule, through the ground coffee, and out through the filter, thus producing the brewed coffee or espresso.

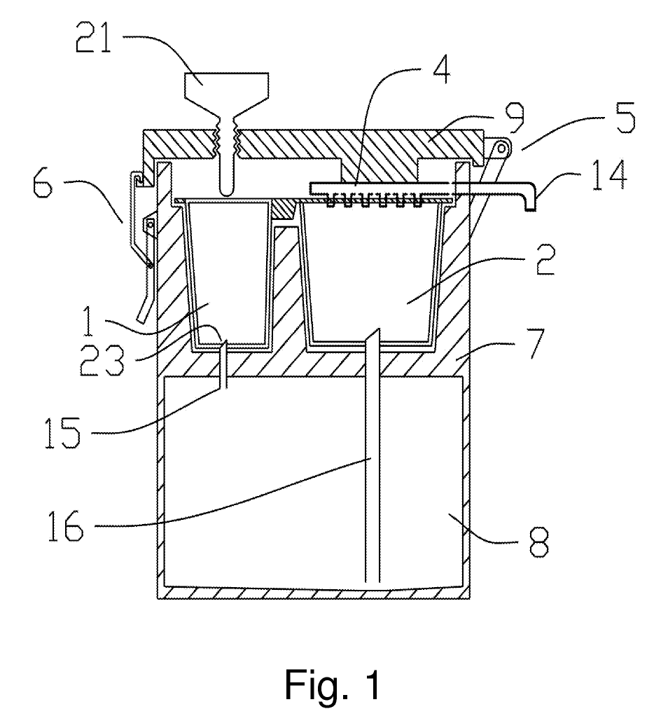

FIG. 1 is an interior view of one embodiment of the invention wherein the gas propellant capsule and coffee capsule are combined in a side by side formation and the brewing cycle is initiated via a separate actuator causing gas capsule venting. As shown in FIG. 1 the brewer is preferably comprised of main body 7, lid 9, hinge 5, latch 6 and output spout 14. The main body 7 includes upper chambers with locations for the combined gas capsule 1 and coffee capsule 2 and a lower water chamber 8 for water storage. Also included in the main body 7 is a gas capsule piercing tube 15 and a coffee capsule piercing tube 16. The lid 9 also includes a screw down actuator 21 used to initiate brewing and a puncture filter collector 4 used to puncture the coffee capsule, and filter and collect the output infused beverage. In use, lid 9 is opened and water is added to the water chamber 8 by pouring water into the coffee capsule 2 area which flows down through tube 16 and into water chamber 8. Next, the combined gas capsule 1 and coffee capsule 2 are placed into the associated upper chambers. The lid 9 is then closed and latched with latch 6. As the lid 9 is closed puncture filter collector 4 punctures the top of the coffee capsule 2 and presses down on the coffee capsule to cause capsule piercing tube 16 to puncture the bottom of the coffee capsule 2. The closing of lid 9 also creates a gas tight seal between the lid 9 and main body 7 of the brewer. To initiate the brewing cycle actuator (or venting mechanism) 21 is rotated causing it to press down on gas capsule 1 which causes puncture tube 15 to puncture weak spot 23 in the gas capsule 1, thus venting the gas capsule. Venting the gas capsule 1 causes a rise in pressure in the water chamber 8, forcing water up through tube 16, up through the coffee capsule 2, through and into the filter collector 4, and out the output spout 14. As shown in FIG. 1, filter collector 4 acts as a filtration member or element.

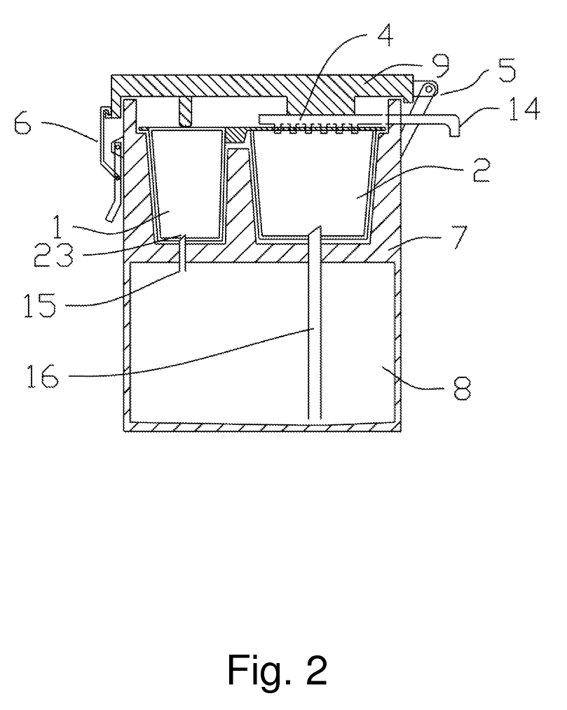

FIG. 2 is an interior view of one embodiment of the invention wherein the gas propellant capsule and coffee capsule are combined in a side by side formation and the brewing cycle is initiated by lid closing causing gas capsule venting. This device is identical to the device of FIG. 1 with the exception that closing lid 9 initiates the brewing cycle. As lid 9 is closed and latched with latch 6 it first causes puncture of the coffee capsule top and bottom, then forms a gas tight seal, then presses down on gas capsule 1, causing puncture and venting, thus initiating the brewing cycle. As shown in FIG. 2, the invention preferably includes a main body 7, lid 9, hinge 5, latch 6 and output spout 14. The main body 7 includes upper chambers with locations for the combined gas capsule 1 and coffee capsule 2 and a lower water chamber 8 for water storage. Also included in the main body 7 is a gas capsule piercing tube 15, a coffee capsule piercing tube 16 and puncture filter collector 4. FIG. 2 also shows how the gas capsule 1 preferably includes weak spot 23.

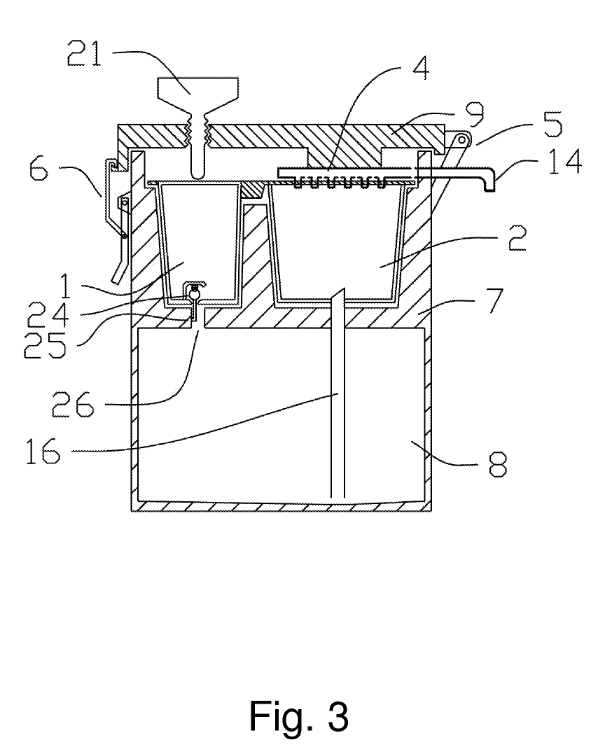

FIG. 3 is an interior view of one embodiment of the invention wherein the gas propellant capsule and coffee capsule are combined in a side by side formation and the brewing cycle is initiated via a separate actuator operating a gas capsule valve. The embodiment shown in FIG. 3 is identical to the device of FIG. 1 with the exception that gas capsule venting is achieved with a valve actuation rather than a puncture. The gas capsule 1 includes a spring loaded normally closed ball valve 24 which must be pressed up to open. The main body 7 includes a gas flow port 26 and a valve actuator 25. When actuator 21 is rotated it presses down on gas capsule 1 causing actuator 25 to open ball valve 24, thus venting the gas capsule 1. Gas flows through gas flow port 26, causing a rise in pressure in water chamber 8, thus initiating the brewing cycle. As shown in FIG. 3, the invention preferably includes a main body 7, lid 9, hinge 5, latch 6, coffee capsule 2, and output spout 14. The main body 7 includes upper chambers with locations for the combined gas capsule 1 and coffee capsule 2 and a lower water chamber 8 for water storage. Also included in the main body 7 is a coffee capsule piercing tube 16 and puncture filter collector 4.

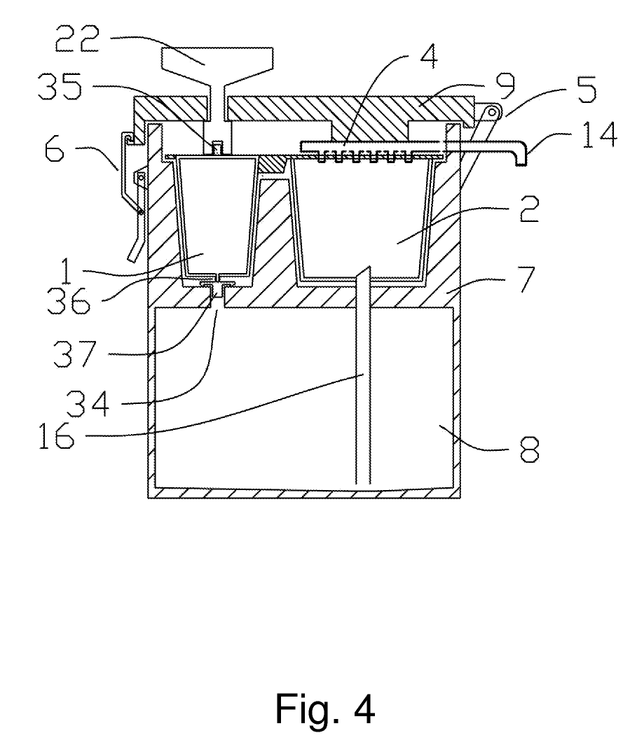

FIG. 4 is an interior view of one embodiment of the invention wherein the gas propellant capsule and coffee capsule are combined in a side by side formation and the brewing cycle is initiated via a separate actuator applying a rotational force. This device is identical to the device of FIG. 1 with the exception that gas capsule venting is achieved with a rotational force. As shown in FIG. 4, the gas capsule 1 includes a top tab 35, a bottom shear tube 36 and a bottom locating tab 37. The main body 7 includes a gas flow slot 34 which mates with gas capsule locating tab 37. The actuator 22 includes a rectangular slot that mates with gas capsule top tab 35. When the gas capsule 1 is placed into the main body 7 chamber, tab 37 fits into slot 34. After the lid 9 is closed, brewing is initiated by rotating actuator 22 which in turn rotates gas capsule 1 causing shear tube 36 to break, thus venting the gas capsule and causing brewing to begin. As shown in FIG. 3, the invention preferably includes a main body 7, lid 9, hinge 5, latch 6, coffee capsule 2, and output spout 14. The main body 7 includes upper chambers with locations for the combined gas capsule 1 and coffee capsule 2 and a lower water chamber 8 for water storage. Also included in the main body 7 is puncture filter collector 4.

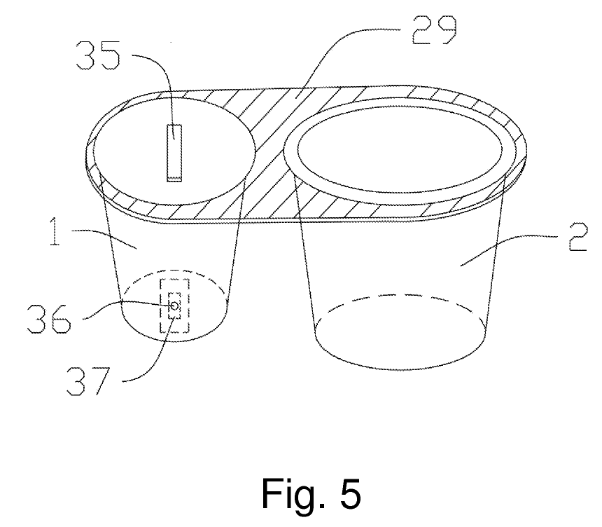

FIG. 5 is a perspective view of one embodiment of an integrated side by side gas capsule coffee capsule combination. As shown in FIG. 5, the gas capsule 1 preferably includes a top tab 35, a bottom shear tube 36 and a bottom locating tab 37. The coffee capsule 2 is preferably linked to the gas capsule 1 with link plate 29. The link plate 29 is so constructed so that with rotational force applied to top tab 25 the gas capsule 1 may rotate with respect to link 29. Although FIG. 5 shows top tab 35 and bottom locating tab 37 as rectangular, it should be understood that the tabs can be any shape that may be twisted or rotated.

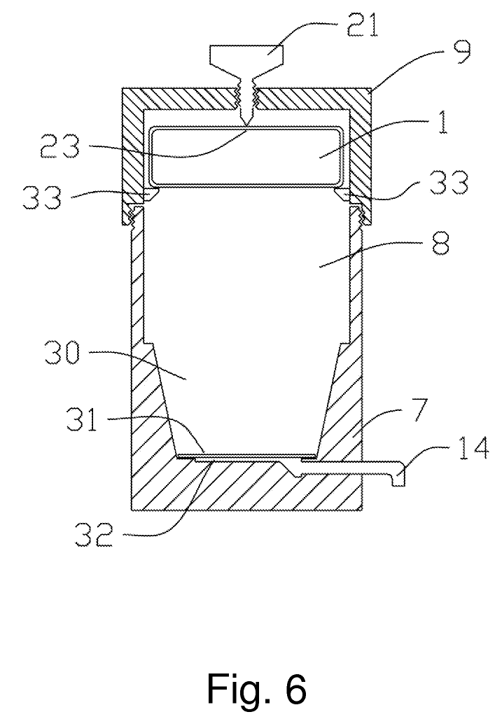

FIG. 6 is an interior view of one embodiment of the invention wherein the gas capsule is separate and coffee is manually packed into the brewer. As shown in FIG. 6, the manually packed coffee and the gas propellant capsule are placed separately in a cylindrical brewing device. The brewer is preferably composed of main body 7, lid 9, actuator (or venting mechanism) 21, and output spout 14. The main body 7 includes an area for water 8, an area for coffee packing 30, a filter plate 31, a beverage collection area 32 and output spout 14. The lid 9 includes support tabs 33 to hold gas capsule 1 into the lid cavity, and screw down screw actuator 21 to cause venting of gas capsule 1. The gas capsule 1 is preferably oval or rectangular in shape and has an intentional weak spot 23 to facilitate venting. In use the device is opened and the gas capsule 1 is placed into the lid cavity and rotated so that support tabs 33 retain the gas capsule 1 in the lid 9. Coffee grounds are manually packed into coffee area 30. Hot water is added to water area 8. The device is closed by screwing lid 9 onto main body 7, forming a gas tight seal. Actuator 21 is rotated to screw down and puncture gas capsule 1 at weak spot 23, thus venting the gas capsule. This results in a rise in chamber pressure causing the water to flow downward through the coffee grounds, through the filter plate 31, into the collection area 32, and out of the output spout 14. Although FIG. 6 shows that the lid 9 is screwed on, it should be understood that the lid 9 may be connected to main body 7 through any connection means.

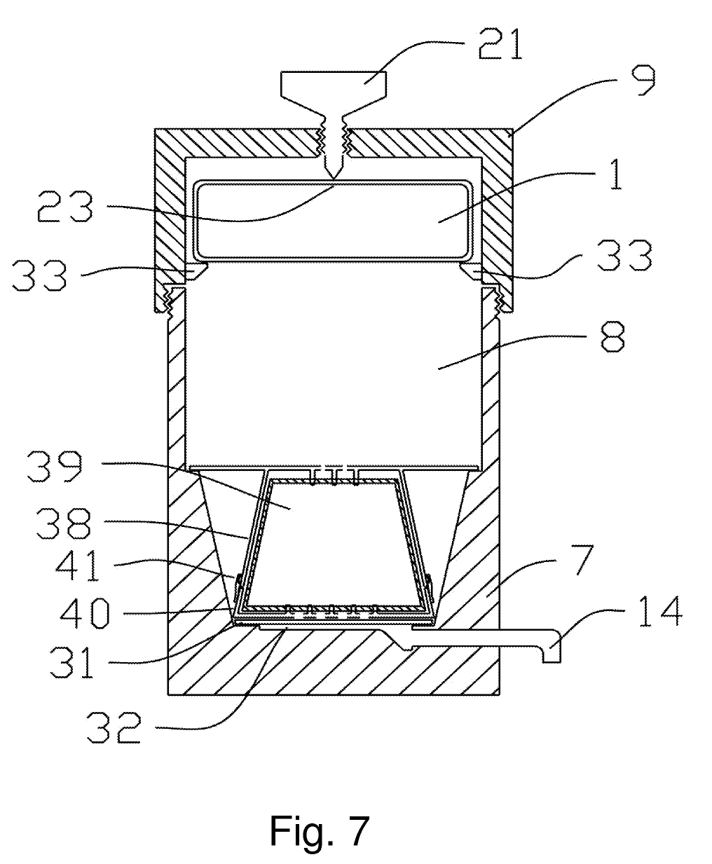

FIG. 7 is an interior view of one embodiment of the invention wherein the gas capsule is separate and an adapter allows for the use of various existing coffee capsules. FIG. 7 is an interior view of one embodiment of the invention wherein the gas capsule 1 is located and oriented as in FIG. 6 but coffee capsule adapters 38, 40, 41 are employed to adapt to (locate and hold) existing coffee capsules 39. The adapter is composed of two sections, the upper section 38 and the lower section 40. Both sections have internal protrusions to puncture the existing coffee capsule and both sections have holes to allow fluid flow. All elements of this device are the same as FIG. 6 except for this coffee capsule adapter. In use an existing coffee capsule 39 is placed into the coffee capsule adapter upper section 38. Next the capsule adapter is closed by fitting the lower section 40 onto the upper section 38. Once closed spring clips 41 secure the two sections together. Although spring clips are shown to secure the two sections, any clip or connector can be used. When the capsule adapter is closed protrusions on the inside of the upper section and the inside of the lower section puncture the existing coffee capsule 39, making it ready for brewing. The adapter is placed into the device, water is added and the device is closed. Actuator 21 is rotated to cause gas capsule venting and initiate the brewing cycle. This results in a rise in chamber pressure causing the water to flow downward through the capsule adapter upper section 38, through the existing coffee capsule 39, through the capsule adapter lower section 40, through the filter plate 31, into the collection area 32, and out of the output spout 14. The lid 9 includes support tabs 33 to hold gas capsule 1 into the lid cavity, and screw down screw actuator 21 to cause venting of gas capsule 1. The gas capsule 1 is preferably oval or rectangular in shape and has an intentional weak spot 23 to facilitate venting. In use, the device is opened and the gas capsule 1 is placed into the lid cavity and rotated so that support tabs 33 retain the gas capsule 1 in the lid 9.

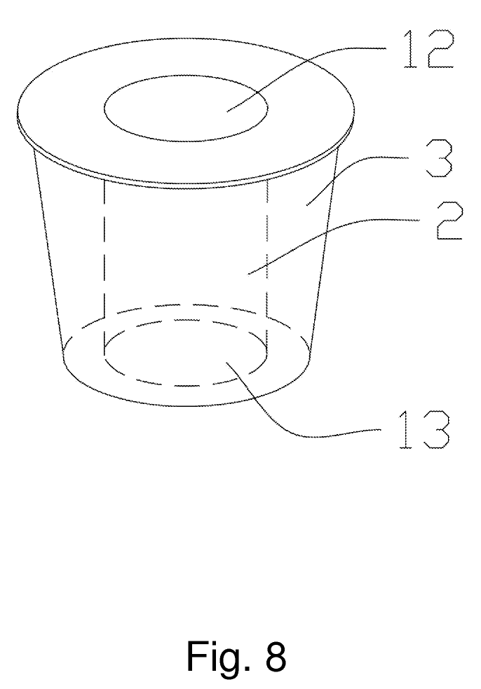

FIG. 8 is a perspective view of one embodiment of an integrated concentric gas capsule coffee capsule combination. The gas capsule 3 concentrically surrounds the coffee capsule 2. The central coffee capsule has an upper seal 12 and a lower seal 13. Alternately the gas and coffee locations could be reversed with the gas capsule in the center and the coffee capsule surrounding the gas capsule.

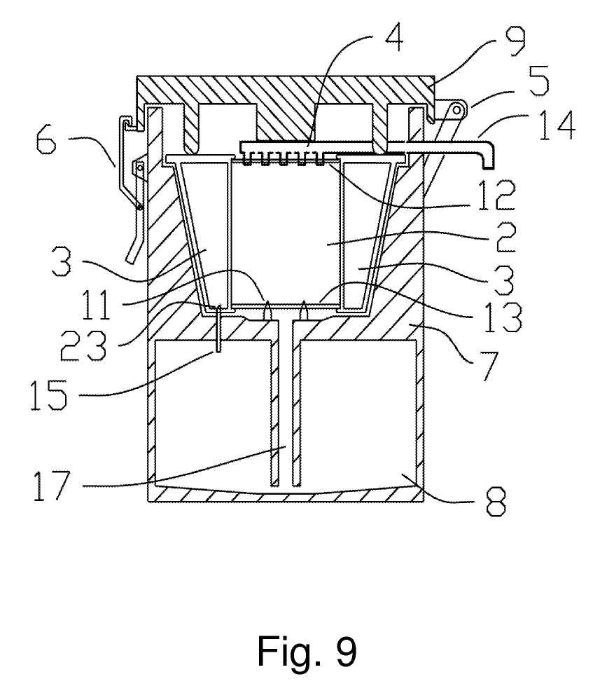

FIG. 9 is an interior view of one embodiment of the invention wherein the gas propellant capsule and coffee capsule are combined in a concentric formation and the brewing cycle is initiated by lid closing causing gas capsule venting. FIG. 9 is an interior view of one embodiment of the invention wherein the gas propellant capsule 3 is combined in a concentric formation with a coffee capsule 2 in a cylindrical brewing device. As shown in FIG. 9 the brewer is composed of main body 7, lid 9, hinge 5, latch 6 and output spout 14. The main body 7 includes an upper chamber location for the concentric gas coffee capsule and a lower water chamber 8 for water storage. Also included in the main body 7 is a gas capsule piercing tube 15, coffee capsule piercing pins 11, and a water flow tube 17. The lid 9 also includes protrusions to press down the concentric capsule and a puncture filter collector 4 used to puncture the coffee capsule, and filter and collect the output beverage. In use lid 9 is opened and water is added to the water chamber 8 by pouring water into the concentric capsule area which flows down through tube 17 and into water chamber 8. Next the concentric gas coffee capsule is placed into the upper chamber. Next the lid 9 is closed and latched with latch 6. As the lid 9 is closed puncture filter collector 4 punctures the top of the coffee capsule 12 and presses down on the coffee capsule to cause coffee piercing pins 11 to puncture the bottom of the coffee capsule 13. Closing lid 9 also forms a gas tight seal between the lid 9 and main body 7 of the brewer and presses down the concentric capsule further which causes puncture tube 15 to puncture weak spot 23 in the gas capsule 3, thus venting the gas capsule. Venting the gas capsule 3 causes a rise in pressure in the water chamber 8, forcing water up through tube 17, up through the coffee capsule 2, through and into the filter collector 4, and out the output spout 14.

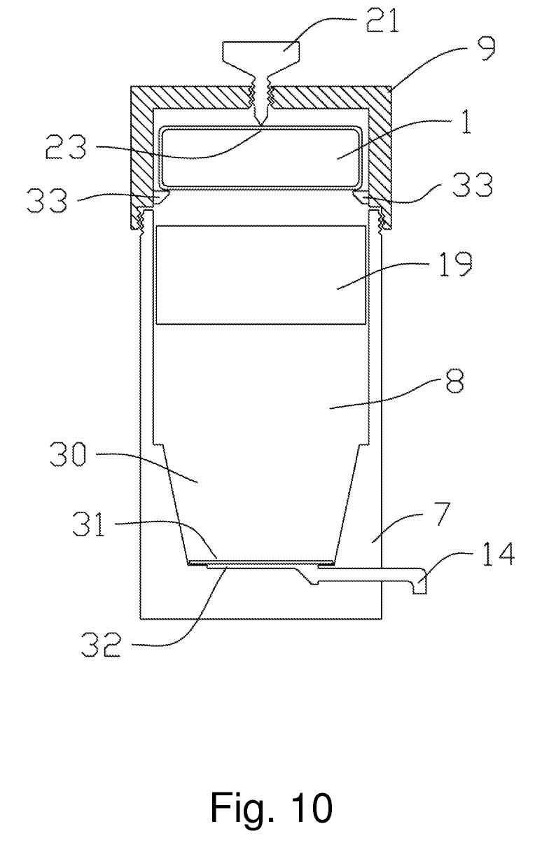

FIG. 10 is an interior view of one embodiment of the invention wherein the gas capsule is separate and coffee is manually packed into the brewer and an intervening element is employed to force water through the coffee grounds. As shown in FIG. 10, there is no coffee capsule and the gas propellant capsule is placed separately in a cylindrical brewing device. As shown in FIG. 10 the brewer is composed of main body 7, lid 9, actuator (or venting mechanism) 21, and output spout 14. The main body 7 includes an area for water 8, an area for adding and packing coffee 30, a filter plate 31, a beverage collection area 32, output spout 14, and intervening element 19. The lid 9 includes support tabs 33 to hold gas capsule 1 into the lid cavity, and screw down screw actuator 21 to cause venting of gas capsule 1. As shown in FIG. 10, the gas capsule 1 is preferably oval or rectangular in shape and has an intentional weak spot 23 to facilitate venting. However, the gas capsule 1 may be any shape and need not have a score or weak spot 23. In use, the device is opened and the gas capsule 1 is preferably placed into the lid cavity and rotated so that support tabs 33 retain the gas capsule 1 in the lid 9. Alternatively, the gas capsule 1 and support tabs 33 can be placed in the body 7, rather than the lid 9. Coffee grounds are manually added to the device and preferably packed into coffee area 30. Hot water is added to water area 8. The intervening element 19 is added to the chamber above the water. The device is closed, preferably by screwing lid 9 onto main body 7, forming a gas tight seal. Actuator 21 is rotated to screw down and puncture gas capsule 1 at weak spot 23, thus venting the gas capsule. This results in a rise in chamber pressure causing the intervening element 19 to move down, in the manner of a piston, and force water to flow downward through the coffee grounds, through the filter plate 31, into the collection area 32, and out of the output spout 14. Although FIG. 10 shows that the lid 9 is screwed on, it should be understood that the lid 9 may be connected to main body 7 through any connection means. FIG. 10 demonstrates how the hot water may be forced through the coffee grounds without the released gas mixing with the water.

An important aspect of the invention is the ability to customize and combine the proper amount of propellant with the proper amount, grind, and compaction of coffee to create any desired type of coffee beverage. Furthermore the brewing device becomes a simple chamber which requires no other power source than that provided by the preloaded gas propellant capsule. Thus, anyone with this brewing device and hot water can make high quality coffee beverages anywhere. In addition to coffee beverages, this invention, using the same technique, can be used to make frothed milk and other hot beverages such as tea, cocoa, etc., by changing the ingredients contained in the one time use, prepackaged capsule.

The devices described here show a rupture pin or twist off tab used to rupture the gas propellant capsule to start the brewing cycle. Many other techniques can be used to accomplish this same result. A trigger mechanism may be utilized which is cocked and then tripped by closing the lid. A valve may be incorporated into the gas propellant capsule which is opened by the lid closing action or a separate trigger action. The gas propellant release mechanism may be a trigger completely separate from the lid closing action.

The invention typically relies on mechanical means to open (or compromise) the upper or lower food capsule seals however, these seals could also be opened or punctured as a result of the pressure increase associated with gas capsule venting.

The device described here and depicted in FIG. 1-5, 8, and 9 shows a combined coffee capsule and gas capsule. However, the gas capsule could be completely separate, used with a separate coffee capsule (FIG. 7) or a receptacle (FIG. 6) in which coffee grounds are placed, without deviating from the scope of the invention.

The invention, as disclosed and depicted in FIG. 1-4,7, and 9 shows a filter member integrated into the beverage outlet. This filter member could be part of the food capsule instead of being a permanent member of the brewing device, without deviating from the scope of the invention.

The invention uses gas pressure acting directly on the contained water to force the water through the coffee chamber. In another embodiment of the invention, the gas pressure may be applied to an intervening element so that the gas is isolated from the contained water. This could be a flexible membrane, bladder, piston, etc., so that the gas pressure acts on this intermediated or intervening device, and that device then presses the water through the coffee chamber.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope of the invention. It is intended that the scope of the invention not be limited by this detailed description, but by the claims and the equivalents to the claims that are appended hereto.

We claim:

1. A beverage brewing device comprising:
a chamber;
a gas propellant capsule;
a venting mechanism; and
a food capsule;
wherein said chamber is comprised of a base, a lid, and an outlet;
wherein said outlet has a filtration member;
wherein said gas propellant capsule is prepackaged, disposable, and single use;
wherein said gas propellant capsule is inserted into said chamber;
wherein said food capsule is prepackaged, disposable, and single use;
wherein said food capsule is inserted into said chamber;
wherein a liquid is introduced into said chamber;
wherein said lid is connected to said base, and wherein connecting said lid to said base establishes an airtight seal capable of withstanding high internal pressure;
wherein said venting mechanism causes a pressurized gas to be released from said gas propellant capsule;
wherein said released pressurized gas causes a rise in pressure in said chamber;
wherein said rise in pressure in said chamber causes said liquid to flow into said food capsule and out of said food capsule through said filtration member, resulting in an infused beverage; and
wherein said infused beverage exits said chamber at said outlet.

2. The beverage brewing device of claim 1 wherein said food capsule contains ground coffee.

3. The beverage brewing device of claim 1, wherein said gas propellant capsule is further comprised of a valve and wherein said valve is opened by said venting mechanism.

4. The beverage brewing device of claim 1, wherein said gas propellant capsule is ruptured by an element selected from the group consisting of a sharp point, mechanical contact, and a rotational force exerted by said venting mechanism.

5. The beverage brewing device of claim 1, wherein said venting mechanism is activated by closing said lid and wherein said venting mechanism is activated only after an airtight seal of said chamber is achieved.

6. The beverage brewing device of claim 1, wherein said food capsule is further comprised of a top seal and a bottom seal, and wherein said top seal and said bottom seal are liquid impermeable.

7. The beverage brewing device of claim 6, wherein at least one of said top seal and said bottom seal rupture at increased pressure to allow said liquid to pass through said at least one ruptured seal.

8. The beverage brewing device of claim 6, wherein at least one of said top seal and said bottom seal rupture at mechanical contact to allow said liquid to pass through said at least one ruptured seal.

9. The beverage brewing device of claim 1 wherein said filtration member is integrally connected to said food capsule.

10. The beverage brewing device of claim 1, wherein said gas propellant capsule is in an interior concentric position and is concentrically surrounded by said food capsule.

11. The beverage brewing device of claim 1, further comprising an intervening element;
wherein said intervening element is located between said liquid and said pressurized air;
wherein said intervening element prevents said pressurized air from mixing with said liquid or mixing with said food in said food receptacle; and
wherein said rise in pressure in said chamber causes said intervening element to cause said liquid to flow into said food receptacle, through said food, and out of said food receptacle through said filtration member, resulting in an infused beverage.

12. A beverage brewing device comprising:
a chamber;
a gas propellant capsule;
a venting mechanism; and
a food receptacle;
wherein said chamber is comprised of a base, a lid, and an outlet;
wherein said outlet has a filtration member;
wherein said lid connects with said base forming an air tight seal;
wherein said gas propellant capsule is a prepackaged, disposable, and single use;
wherein said gas propellant capsule is inserted into said chamber;
wherein said food receptacle is manually filled with a food by a user;
wherein said food receptacle is inserted into said chamber in a location that allows a liquid to flow over said food to produce an infusion;
wherein said liquid is introduced into said chamber;
wherein said lid is connected to said base, and wherein connecting said lid to said base establishes an airtight seal capable of withstanding high internal pressure;
wherein said venting mechanism causes a pressurized gas to be released from said gas propellant capsule;
wherein said released gas causes a rise in pressure in said chamber;
wherein said rise in pressure in said chamber causes said liquid to flow into said food receptacle, through said food, and out of said food receptacle through said filtration member, resulting in an infused beverage; and
wherein said infused beverage exits said chamber at said outlet.

13. The beverage brewing device of claim 12 wherein said food is ground coffee.

14. The beverage brewing device of claim 12, wherein said gas propellant capsule is further comprised of a valve and wherein said valve is opened by said venting mechanism.

15. The beverage brewing device of claim 12, wherein said gas propellant capsule is ruptured by an element selected from the group consisting of a sharp point, mechanical contact, and a rotational force exerted by said venting mechanism.

16. The beverage brewing device of claim 12, wherein said venting mechanism is activated by closing said lid and wherein said venting mechanism is activated only after an airtight seal of said chamber is achieved.

17. The beverage brewing device of claim 12, wherein said food receptacle receives a food capsule rather than a food and wherein said food capsule is prepackaged, disposable, and single use.

18. The beverage brewing device of claim 12, further comprising an intervening element;
wherein said intervening element is located between said liquid and said pressurized air;
wherein said intervening element prevents said pressurized air from mixing with said liquid or mixing with said food in said food receptacle; and
wherein said rise in pressure in said chamber causes said intervening element to cause said liquid to flow into said food receptacle, through said food, and out of said food receptacle through said filtration member, resulting in an infused beverage.
